(19) United States
(12) Patent Application Publication
(10) Pub. No.: US 2023/0103375 A1
(43) Pub. Date: Apr. 6, 2023

(54) HEAVY METAL DETECTOR

(71) Applicant: WUHAN ACADEMY OF AGRICULTURAL SCIENCES, Wuhan (CN)

(72) Inventors: Yifang ZHAN, Wuhan (CN); Jinwei HU, Wuhan (CN); Shaowen SUN, Wuhan (CN); Lihua WANG, Wuhan (CN); Qi YAO, Wuhan (CN); Mingjie CHEN, Wuhan (CN); Tingting LI, Wuhan (CN); Sijie ZHENG, Wuhan (CN); Changchang WANG, Wuhan (CN); Jinyan GUAN, Wuhan (CN); Zheng LI, Wuhan (CN); Xiangru BAI, Wuhan (CN); Jing WEI, Wuhan (CN); Baoxi LI, Wuhan (CN)

(73) Assignee: WUHAN ACADEMY OF AGRICULTURAL SCIENCES, Wuhan (CN)

(21) Appl. No.: 17/906,293

(22) PCT Filed: Jul. 1, 2021
(86) PCT No.: PCT/CN2021/104044

§ 371 Date: Sep. 14, 2022

(30) Foreign Application Priority Data
Dec. 2, 2020 (CN) 202011401600.0

(51) Int. Cl. G01N 27/416; G01N 27/30; G01N 27/28

(52) U.S. Cl. CPC G01N 27/416; G01N 27/30; G01N 27/286

(57) ABSTRACT

A heavy metal detector includes a housing composed of a top cover and a base, and a main machine and an electrolysis module arranged in the housing, wherein the main machine includes a main machine circuit, and the main machine circuit includes a main controller, a power supply module, a signal acquisition and processing module, an electrolysis module interface and a signal conversion module. The electrolysis module interface is configured to connect the electrolysis module and the signal acquisition and processing module; the signal acquisition and processing module is configured to receive a characteristic electrical signal output by the electrolysis module, and output a detection result to the main controller; and the main controller displays the detection result on a display module. Multiple electrolysis module interfaces are provided. The base is provided with a plurality of electrolysis module installation ports and stirring devices corresponding to the electrolysis module installation ports.

### CROSS-REFERENCE TO RELATED APPLICATIONS

This application is a National Stage under 35 U.S.C. 371 of International Patent Application No. PCT/CN2021/104044, filed Jul. 1, 2021, which claims priority to Chinese Patent Application No. 202011401600.0, filed Dec. 2, 2020; the disclosure of all of which are incorporated herein by reference in their entirety.

### TECHNICAL FIELD

The present disclosure relates to heavy metal detection, and in particular to a heavy metal detector.

### BACKGROUND

With an increase in human activities such as agricultural practice, mining and smelting, and industrial production, environmental heavy metal pollution is becoming a very serious problem, and the risk of heavy metal concentrations exceeding the acceptable standard in agricultural products and food is increasing. The quality and safety of agricultural products, food, and the environment are directly related to human health. Heavy metal elements in food, fruits, vegetables, aquatic products, poultry, crops, Chinese medicinal materials, tea, milk powder and other products will be directly absorbed by the human body through the food chain. Excessive concentrations of heavy metals in topical products such as clothing fabrics, furniture paint films, and cosmetics also have an impact on human health. Moreover, heavy metal pollution can cause great harm, is difficult to control, exhibits long metabolic cycles in the human body, and may cause irreversible damage. Therefore, China and most countries in the world have passed laws to prohibit production and business operations of agricultural products (including Chinese medicinal materials) and foods with excessive concentrations of heavy metals, and promulgated strict limit standards and accepted detection methods. At present, detection of low-limit heavy metals in China and other countries mainly relies on large analytical instruments such as atomic absorption, atomic fluorescence, ICP-MS, and ICP-OES. Although these methods are highly sensitive and accurate, sample preparation is complicated and time-consuming, and high temperature, high pressure, and corrosive reagents are frequently required. In addition, sophisticated professionals are required to perform the analysis resulting in high detection cost. These methods are also inconvenient as rapid on-site detection is not possible.

Heavy metal detection paper test strips based on colloidal gold immunochromatography assay (GICA) are available. But, although the strips offer low detection cost, fast results, strong selectivity, using simple equipment, paper tests have disadvantages. The test sensitivity is not optimum, both negative and positive resolution is poor, and the method reproducibility and stability are limited.

XRF series heavy metal detectors based on X-ray fluorescence spectroscopy (XRF) are also currently available. But, XRF testing requires equipment that is expensive and bulky (≥70 kg), and test results can be easily affected by interfering elements and superimposed peaks.

Establishing a fast, sensitive, and specific heavy metal detection method is the key way to solve the above problems. Using effective detection technologies to analyze the content of heavy metals in edible products, daily necessities and environment, can improve the quality thereof so as to protect food safety and human health.

Chinese patent Application No. CN201710346251.9 discloses a portable heavy metal detector and a detection method thereof, including a main machine and an analyzer accessory separated from each other. However, in operation, the claimed detector has the following problems: the detection environment is easily polluted; when a plurality of detectors work simultaneously the analyzer accessories are prone to error; oftentimes communication failures occur between the main machine and the analyzer accessories requiring reconnection and renders the operation complicated. Moreover, the detector is limited to a single-channel detection function, and thus the detection accuracy and stability cannot be guaranteed and randomness is an issue.

Chinese patent Publication No. CN107966485A discloses an electrochemical heavy metal detector based on graphene test paper electrodes. The preparation of the three-dimensional porous graphene assembly used involves concentrated sulfuric acid, concentrated nitric acid, potassium permanganate and the like. In operation, this detector has the following problems: the preparation process is complicated; the production link needs to be secure; a pipette with corresponding range needs to be used in the detection stage to transfer liquid under test and add the liquid to the surface of the working electrode of the graphene test paper electrode. Moreover, professional operators are required to execute the tests; the operation is complicated; and the reproducibility of the test is poor.

In actual use, the detection accuracy and stability of existing electrochemical heavy metal detection instrument cannot meet expectations of instrument developers due to the influence of the operator's electrode plug-in methods and the method of handling liquids.

### SUMMARY

The present disclosure provides a heavy metal detection instrument, which solves the prior art problems of low detection efficiency, low detection accuracy, instability and the like. The present disclosure adopts the following technical solutions to facilitate the installation of electrodes and liquid filling operations by operators, reduce artificially introduced errors, and increase the detection accuracy and stability.

Accordingly, an improved heavy metal detector is provided. The heavy metal detector includes a housing, composed of a top cover and a base, and a main machine and electrolysis module arranged in the housing, wherein the main machine includes a main machine circuit, and the main machine circuit includes a main controller, a power supply module, a signal acquisition and processing module, an electrolysis module interface and a signal conversion module; the main controller is electrically connected to the signal acquisition and processing module, the signal conversion module and the power supply module; the electrolysis module interface is configured to connect the electrolysis module and the signal acquisition and processing module; the signal acquisition and processing module is configured to receive a characteristic electrical signal output by the electrolysis module, and then output a detection result to the main controller; the main controller is configured to display the detection result on a display module; and a plurality of electrolysis module interfaces are provided, and the base is provided with a plurality of electrolysis module installation ports and stirring devices arranged side by side with the electrolysis module installation ports.

In some specific embodiments, the electrolysis module includes an electrode mounting plug and a screen-printed electrode (SPE); the SPE is installed on the electrode mounting plug in a plug-in fashion and electrically connected to the electrolysis module, and the electrode mounting plug is installed on the base in a plug-in fashion and electrically connected to the main machine circuit.

In some other embodiments, the SPE is a double-sided electrode; the double-sided electrode includes a polyethylene terephthalate (PET) substrate and electrodes arranged in mirror on both sides of the PET substrate; and the electrodes include a reference electrode, a working electrode and an auxiliary electrode.

In some embodiments, the SPE is a dual-working electrode; the dual-working electrode includes a reference electrode, a first working electrode, a second working electrode and an auxiliary electrode arranged on one side of the PET substrate, and the first working electrode, the second working electrode and the auxiliary electrode are all L-shaped.

In some embodiments, the electrode mounting plug is provided with a plug interface for installing the SPE, a guide groove is vertically arranged on an outside of the plug interface, and upper and lower ends of the guide groove are open; and the SPE is installed in the plug interface and is partially disposed in the guide groove.

In some embodiments, the guide groove includes a first side, a second side and a groove bottom plate, the first side and the second side are respectively disposed on both sides of the groove bottom plate; upper edges of the first side, the second side and the groove bottom plate are flush; and a length of the first side is greater than a length of the groove bottom plate, and the length of the groove bottom plate is greater than a length of the second side.

In some embodiments, the first side includes a first side plate, the first side plate is provided with a first limiting rib, the first side plate and the groove bottom plate are perpendicular to each other, the first side plate and the first limiting rib are perpendicular to each other, the groove bottom plate and the first limiting rib are parallel to each other and disposed on the same side of the first side plate, an upper end of the first side plate is flush with an upper end of the first limiting rib, and a length of the first side plate is greater than a length of the first limiting rib. The second side includes a second side plate, the second side plate is provided with a second limiting rib, the second side plate and the groove bottom plate are perpendicular to each other, the second side plate and the second limiting rib are perpendicular to each other, the groove bottom plate and the second limiting rib are parallel to each other and disposed on the same side of the second side plate, an upper end of the second side plate is flush with an upper end of the second limiting rib, and a length of the second side plate is greater than a length of the second limiting rib; and the guide groove is formed by the first side plate together with the first limiting rib, the groove bottom plate, the second side plate, and the second limiting rib.

In some embodiments, the stirring device includes a stirring barrel, a reaction cell and a drive motor, the drive motor is embedded in the housing of the main machine and disposed on the bottom of the stirring barrel, the drive motor is a rotating motor or an eccentric motor, the drive motor is configured to drive the stirring barrel to rotate or vibrate quickly, and the reaction cell is detachably disposed in the stirring barrel, and follows the rotation or vibration of the stirring barrel during detection.

In some embodiments, the signal conversion module is connected to a voice prompt module and the display module, the voice prompt module receives an instruction of the controller conveyed by the signal conversion module and performs voice broadcast, and the display module includes a running indicator and an LCD touch screen.

In some embodiments, the detector further includes an external interface module, wherein the external interface module is disposed on a rear side of the base and includes a serial port RS232 interface, a USB interface, an Ethernet interface, a Mini USB interface, and a power socket.

The present disclosure has the following advantages and beneficial effects:

By providing a plurality of electrolysis module interfaces, a plurality of electrolysis modules may be connected, increasing the number of detection units of the detector, enabling a plurality of detections simultaneously. Moreover, special docking is realized through the electrolysis module interface, which is convenient to use. The simultaneous use of a plurality of electrolysis modules improves the efficiency and can obtain a plurality of reference results, making the results more reliable.

By providing the electrode mounting plug that is installed on the base in a plug-in fashion and electrically connected to the main machine circuit, it is convenient to remove the electrode mounting plug to install the SPE, avoiding the inconvenience caused by the operation of the entire instrument. At the same time, the SPE can be installed in place, improving the detection accuracy.

By providing mirror-symmetrical electrodes on a PET substrate, it is equivalent to adding a detection unit to obtain two sets of data results by performing detection on the same detection object once to obtain reference data of two results with the same detection object and environment, thereby avoiding errors caused by one single result. Comparison of two sets of results of the double-sided electrode of a mirror symmetry structure can reflect the difference between the tangential contact angle of the rotating liquid surface of the electrode and the effective contact area. More accurate values are obtained through comparison and analysis of the two data sets.

By providing a guide groove at the end of the electrode socket, the insertion position of the SPE can be limited in both the horizontal and vertical directions at the same time, ensuring a constant position of the electrode reaction zone during detection, that is, it is always disposed in the center area of the reaction cell. The plug-in connection between the electrode plug and the instrument fixes the electrode immersion depth and facilitates the plug-in operation of the electrode, improving the detection accuracy and stability.

### BRIEF DESCRIPTION OF THE DRAWINGS

The appended drawings described here are intended to provide a further understanding of the embodiments of the present disclosure, which constitute a part of the present disclosure, and do not constitute a limitation to the embodiments of the present disclosure, in which:

FIG. 1 schematically shows a block diagram of a system structure of a heavy metal detector according to an embodiment of the present disclosure;

FIG. 2 schematically shows a three-dimensional structure of a heavy metal detector according to an embodiment of the present disclosure;

FIG. 3 schematically shows a structure of an electrode plug;

FIG. 4 schematically shows a structure of the other side of the electrode plug;

FIG. 5 schematically shows structure of external interface modules;

FIG. 6 schematically shows an electrode structure on one side of a double-sided electrode;

FIG. 7 schematically shows a structure of a single-sided of SPE with dual-working electrode;

FIG. 8 schematically shows an overall structure of an electrolysis module;

FIG. 9 schematically shows an assembly of the electrolysis module and a base;

FIG. 10 schematically shows a structure of a single-sided of SPE with dual-working electrode with locating holes;

FIG. 11 schematically shows another embodiment of a guide groove and a structure with locating projections;

FIG. 12 schematically shows an assembly structure of a guide groove with locating projections and an electrode with locating holes;

FIG. 13 schematically shows a structure of a guide groove with locating projections.

### REFERENCES

1. LCD touch screen
2. power switch button
3. housing
4. running indicator
5. top cover
6. function expansion module
7. base
8. stirring device
9. screen-printed electrode (SPE)
10. guide groove
11. electrode plug
12. movable flip
13. RS232 serial interface
14. USB interface
15. Ethernet interface
16. Mini USB interface
17. power socket
18. PET substrate
19. reference electrode
20. working electrode
21. auxiliary electrode
22. reaction cell
23. stirring barrel
24. rotating motor
101. first side
102. groove bottom plate
103. second side
101a. first side plate
101b. first limiting rib
103a. second side plate
103b. second limiting rib
20-1. first working electrode
20-2. second working electrode
25-1. first locating hole
25-2. second locating hole

### DETAILED DESCRIPTION

The present disclosure is further described in detail below with reference to the embodiments and drawings. The exemplary embodiments and descriptions of the present disclosure are merely intended to explain the present disclosure, rather than a limitation of the present disclosure.

Before explaining the present disclosure in more detail, it may be helpful to understand the present disclosure by providing definitions of certain terms used herein.

The terms first, second, and the like are merely used for distinguishing description, and shall not be understood as indicating or implying relative importance. Although the terms first, second, and the like may be used herein to describe various units, these units should not be limited by these terms. These terms are merely intended to distinguish one unit from another. For example, a first unit may be referred to as a second unit, and the second unit may be similarly referred to as the first unit without departing from the scope of the exemplary embodiment of the present disclosure.

When a unit is referred to as being “connected to”, “connected with” or “coupled to” the other unit, it may be directly connected or coupled to the other unit, or intervening units may exist. In contrast, when a unit is referred to as being “directly connected to” or “directly coupled to” the other unit, no intervening unit exists. Other words used to describe the relationship between units should be interpreted in a similar way (e.g., “between” and “directly between”, “adjacent” and “directly adjacent”, and the like).

In the description of the present disclosure, it should also be noted that, unless otherwise clearly defined and limited, the terms “provide”, “install”, and “connect” should be understood in a broad sense. For example, it may be a fixed connection, a detachable connection, or an integral connection; it may be a mechanical connection or an electrical connection; and it may be a direct connection or an indirect connection through an intermediate medium, and it may be an internal communication between two components. For those of ordinary skill in the art, the specific meanings of the above terms in the present disclosure can be understood in specific situations.

The terms used herein are merely intended to describe specific embodiments, rather than limiting the exemplary embodiments of the present disclosure. As used herein, singular forms “a”, “an” and “the” are intended to include plural forms unless the context clearly indicates the opposite. It should also be understood that the terms “include”, “including”, “comprise”, and/or “comprising” when used herein, specify the existence of the stated features, integers, steps, operations, units and/or components and do not exclude the existence or addition of one or more other features, quantities, steps, operations, units, components, and/or their combinations; the term “and/or” used herein is merely an association relationship describing related objects, which means that three relationships may exist, for example, A and/or B means that: A alone exists, B alone exists, and A and B exist at the same time. The term “/and” used herein describes another association relationship of objects, which means that two relationships may exist, for example, A/and B means that: A alone exists, and A and B alone exist. In addition, the character “/” used herein generally means that the associated objects before and after are of an “or” relationship.

The anodic stripping voltammetry (ASV) was invented in the 1820s, which refers to an electrochemical analysis method in which metal ions under test are partially reduced to metal at a certain potential and precipitated on a surface of an electrode, and then a reverse voltage is applied to the electrode such that the metal on the electrode oxidizes to generate an oxidation current, and analysis is performed according to a current-voltage curve of the oxidation process. This method has the advantages of fast measurement speed, low detection limit, and can be used for simultaneous qualitative and quantitative analysis of a plurality of metal elements.

Screen-printed electrode (SPE), also called as thick-film electrode, includes a working electrode, a reference electrode and an auxiliary electrode, which is an electrochemical sensor prepared by thick-film integrated circuit technology. Recognition molecules (such as enzymes, antibodies, or nucleic acids) are often immobilized on the surface of the working electrode. SPEs usually have a Ag/AgCl layer as a reference electrode. The main advantages of screen printing technology include: flexible design, easy automatic mass production in the printing process, convenient use, good reproducibility, easy modification, and suitability for various materials.

Specific details are set forth in the following description to facilitate a complete understanding of the exemplary embodiments. However, those of ordinary skill in the art should understand that the exemplary embodiments can be implemented without these specific details. For example, the system can be shown in a block diagram to avoid unnecessary details to make the example unclear. In other instances, well-known procedures, structures, and techniques may not be shown in unnecessary details to avoid making the example embodiments unclear.

FIG. 2 shows a schematic diagram of a three-dimensional structure of a heavy metal detector according to an embodiment of the present disclosure. As shown in FIG. 2, the heavy metal detector includes a housing 3. The housing 3 is divided into two parts, i.e., a top cover 5 and a base 7. A main machine and an electrolysis module are disposed within the housing 3. The main machine includes a main machine circuit. A LCD touch screen 1 and a movable flip 12 are disposed at an upper end of the top cover, in which the LCD touch screen 1 is disposed on a left side, and the movable flip 12 is disposed on a right side. The LCD touch screen 1 is used as a human-computer interaction platform, and its interface includes a variety of function buttons for users to send instructions. The LCD touch screen 1 displays an online detection status and a final detection result. A power switch button 2 is disposed on a lower front of the LCD touch screen 1. A running indicator 4 is disposed on a front side of the top cover 5. When the power switch button 2 is turned on, the running indicator 4 lights up, and the LCD touch screen 1 displays a human-computer interaction page. The movable flip 12 can be rotated up and down 120° around an axis, and intends to prevent dust, water, and shock to ensure a clean and tidy detection environment. Below the movable flip are a function expansion module 6 and a stirring module (such as a stirring device 8) arranged on the base 7 respectively.

The function expansion module 6 is a reserved position, and exclusive function modules can be customized according to user needs, such as weighing module, for example, a high-precision balance may be added for sample weighing; printing module, for example, a small printer may be added for printing detection results; and pre-treatment module, for example, a corresponding equipment may be added according to pre-treatment process requirements.

In some embodiments, the electrolysis module includes an electrode plug (i.e., an electrode mounting plug) 11 and a SPE 9. The electrolysis module is connected to the base through an electrolysis module interface. A plurality of electrolysis modules with the same structure and a plurality of corresponding electrolysis module interfaces may be provided. The electrolysis module interface includes an electrolysis module installation port and the stirring device 8 that are arranged on the base, in which the stirring device 8 and the electrolysis module installation port are arranged side by side. As shown in FIG. 9, the base is provided with two electrolysis module installation ports (i.e., notches on the base) that are matched with two electrolysis modules, and two stirring devices arranged side by side with them. The SPE 9 is installed on the electrode mounting plug 11 in a plug-in fashion and electrically connected to the circuit inside the electrolysis module. The electrode mounting plug 11 is installed on the base in a plug-in fashion and electrically connected to the main machine circuit.

By providing a plurality of electrolysis module interfaces, a plurality of electrolysis modules may be connected, increasing the number of detection units of the detector, enabling a plurality of detections at the same time. Moreover, special docking is realized through the electrolysis module interface, which is convenient to use. The simultaneous use of a plurality of electrolysis modules improves the efficiency and can obtain a plurality of reference results, making the results more stable.

By providing the electrode mounting plug that is installed on the base in a plug-in fashion and electrically connected to the main machine circuit, it is convenient to remove the electrode mounting plug to install the SPE, avoiding the inconvenience caused by the operation on the entire instrument. At the same time, the SPE can be installed in place, improving the detection accuracy.

In some embodiments, a rear side of the base 7 is provided with an external interface module. The heavy metal detector communicates with the outside through the external interface module. As shown in FIG. 5, the external interface module includes a RS232 serial interface 13, a USB interface 14, an Ethernet interface 15, a Mini USB interface 16 and a power socket 17.

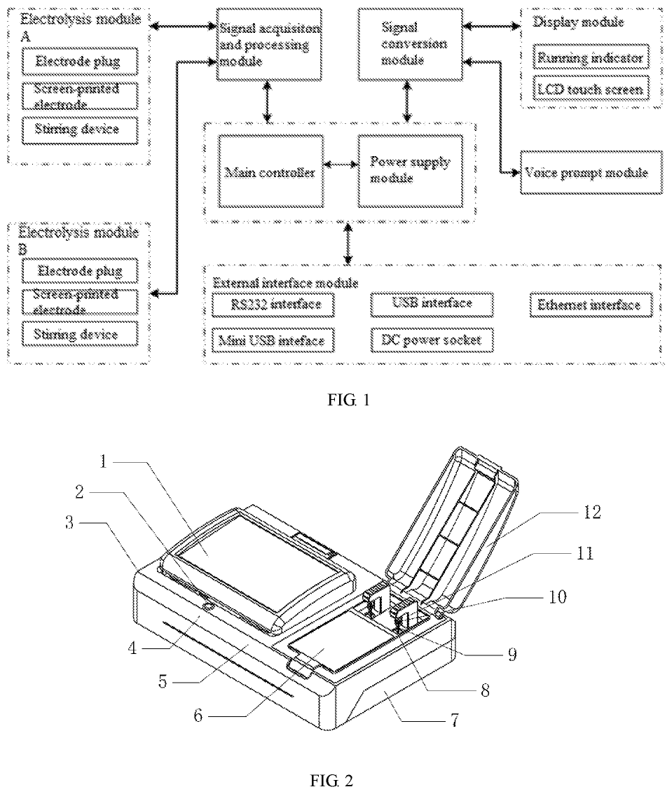

FIG. 1 shows a schematic block diagram of a system structure of a heavy metal detector according to an embodiment of the present disclosure, in which main modules, such as a main machine circuit and an electrolysis module are shown. The main machine circuit includes a main controller, a power supply module, a signal acquisition and processing module, an electrolysis module interface, and a signal conversion module. The main controller is electrically connected to the signal acquisition and processing module, the signal conversion module and the power supply module. The electrolysis module interface is configured to connect the electrolysis module with the signal acquisition and processing module. The signal acquisition and processing module is configured to receive a characteristic electrical signal output by the electrolysis module, and then output a detection result to the main controller. The main controller displays the result on a display module. In some embodiments, the signal conversion module is connected to a voice prompt module and the display module. The voice prompt module receives an instruction of the main controller conveyed by the signal conversion module, and then performs voice broadcast. The main controller displays the detection result on the display module through the signal conversion module.

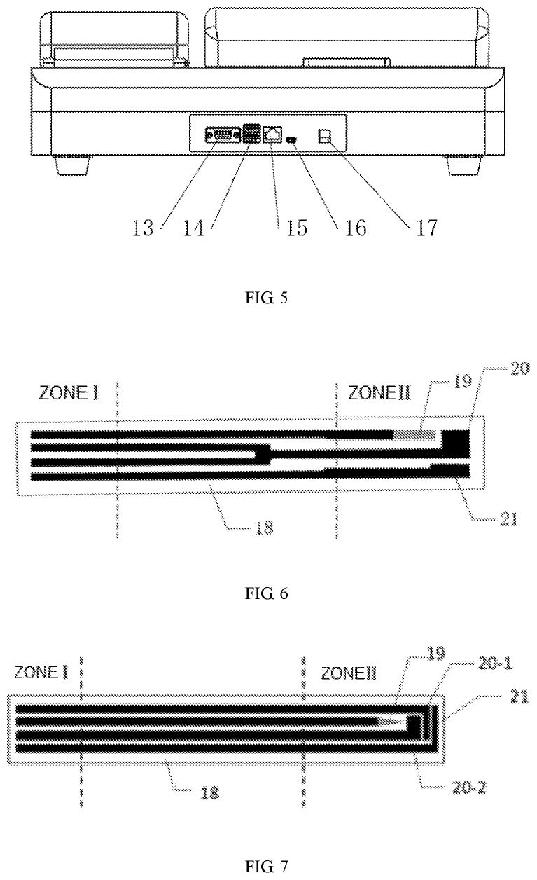

In a possible embodiment, the SPE is a double-sided electrode. The double-sided electrode includes a PET substrate and electrodes arranged in mirror on both sides of the PET substrate. As shown in FIG. 6, the electrodes include a reference electrode 19, a working electrode 20 and an auxiliary electrode 21. When in use, the detection is divided into two processes: 1, enrichment; and 2, dissolution. During the enrichment process, the metal being tested is in a stirring liquid that contacts or is adsorbed by the working electrode, it is reduced to metal on the working electrode and attached to the working electrode. This process is affected by a stirring speed and a tangential contact angle of the liquid to the working electrode. For example, electrode insertion skew and slight electrode bending abnormality back and forth will cause variations in detection results. Since an original single working electrode only detects one set of numbers, and the abnormality caused by the influencing factors in the enrichment stage cannot be reflected, a final abnormal value may be higher or lower. The mirror symmetry structure of the double-sided electrode enables two working electrodes to be in the same test environment, and the two working electrodes are oppositely affected by the overall position of the motor. Under normal circumstances, two sets of data will present a fixed ratio range, but when a large abnormality in the ratio of two sets of results occurs due to electrode insertion skew and slight electrode bending abnormality back and forth, the instrument may prompt to re-test. On one hand, providing mirror-symmetrical electrodes on a PET substrate, is equivalent to adding a detection unit to obtain two sets of data results by performing detection on the same detection object once and obtain reference data of two results with the same detection object and environment, avoiding errors caused by one result. On the other hand, the mirror symmetry design of the double-sided electrode makes it convenient to reflect the difference between the tangential contact angle of the rotating liquid surface of the electrode and the effective contact area. When an individual electrode is slightly inserted skew or slightly deformed due to bending back and forth, which will cause the difference to be significantly larger, more accurate values can be obtained through comparison and analysis of the two sets of data. A detection result with larger difference can be determined as an abnormal value by a data analysis software and re-measurement is recommended.

In a possible embodiment, as shown in FIG. 7, the SPE is a dual-working electrode. The dual-working electrode includes a reference electrode 19, a first working electrode 20-1, a second working electrode 20-2 and an auxiliary electrode 21 provided on one side of a PET substrate 18. The first working electrode, the second working electrode and the auxiliary electrode are all L-shaped. By providing two working electrodes for detection, two data results are obtained by detecting the same detection object once. That is, reference data of two results with the same detection object and environment are obtained, avoiding errors caused by one result.

In some embodiments, the above dual-working electrode is a single-sided dual-working electrode. When designing the single-sided dual-working electrode, the areas of the working electrodes are controlled to a certain proportion, and the proportion of the current signals of the two working electrodes is analyzed through a software to determine a validity of the results. During implementation, a channel for corresponding data is designed through instrument hardware, avoiding the influence of factors such as the effective contact area and angle change of the solution under test and the working electrode, during the enrichment processes of a plurality of measurement on the detection results, and removing abnormal values. When analyzing a double-electrode signal, a correction algorithm is introduced through a detection software.

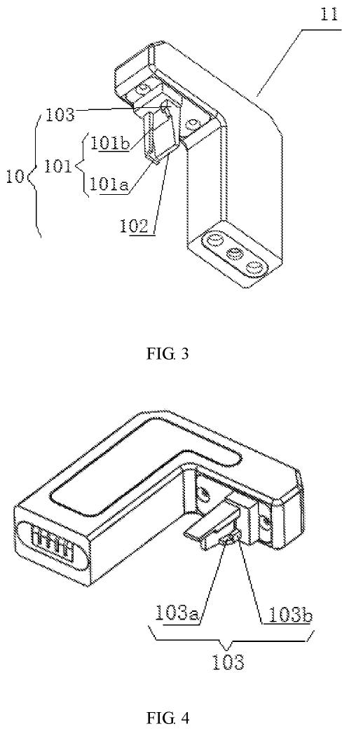

In a possible embodiment, as shown in FIG. 3 and FIG. 4, the electrode mounting plug 11 is provided with a plug-in interface for installing a SPE. The plug-in interface is an interface for installing an electrode. A guide groove 10 is vertically arranged on the outside the plug interface for fixing the position of the electrode. Upper and lower ends of the guide groove 10 are open. The SPE 9 is installed in the plug interface and is partially disposed in the guide groove 10. By providing the guide groove, the problem that the detection result is affected by an improper mounting position of the electrode due to user error is avoided. At the same time, the guide groove can guide and limit the installation, which can further avoid the problem that the detection result is affected by non-standard installation of the electrode, thereby improving the detection accuracy.

Moreover, with the addition of the guide groove and the use of the plug-in connection, the stability of the instrument is further enhanced, and the stability of the detection results is better, such that the stability of the detection results of different testers is significantly enhanced. In other words, adding a locating device and adopting a plug-in connection can significantly improve the stability of the detection results, reduce personnel operating errors, and beneficially improve the on-site adaptability of the instrument.

In some embodiments, the guide groove 10 includes a first side 101, a second side 103 and a groove bottom plate 102. The first side 101 and the second side 103 are respectively disposed on both sides of the groove bottom plate 102. Upper edges of the first side 101, the second side 103 and the groove bottom plate 102 are flush. A length of the first side 101 is greater than a length of the groove bottom plate 102. The length of the groove bottom plate 102 is greater than a length of the second side 103. By setting the lengths of the first side, the groove bottom plate and the second side to be reduced sequentially, the electrode can be easily located and installed from the first side as the first position when installing the electrode, improving the accuracy and consistency of the installation position.

In some embodiments, the first side 101 includes a first side plate 101a. The first side plate 101a is provided with a first limiting rib 101b. The first side plate 101a and the groove bottom plate 102 are arranged perpendicularly. The first side plate 101a and the first limiting rib 101b are arranged perpendicularly. The groove bottom plate 102 and the first limiting rib 101b are arranged in parallel and disposed on the same side of the first side plate 101a. An upper end of the first side plate 101a is flush with an upper end of the first limiting rib 101b. A length of the first side plate 101a is greater than a length of the first limiting rib 101b. As shown in FIG. 4, the second side 103 includes a second side plate 103a. The second side plate 103a is provided with a second limiting rib 103b. The second side plate 103a and the groove bottom plate 102 are arranged perpendicularly. The second side plate 103a and the second limiting rib 103b are arranged perpendicularly. The groove bottom plate 102 and the second limiting rib 103b are arranged in parallel and disposed on the same side of the second side plate 103a. An upper end of the second side plate 103a is flush with an upper end of the second limiting rib 103b. A length of the second side plate 103a is greater than a length of the second limiting rib 103b. The first side plate 101a, the first limiting rib 101b, the groove bottom plate 102, the second side plate 103a, and the second limiting rib 103b form the guide groove 10.

The limiting ribs on the two side plates realize further limiting, such that the position is more accurate.

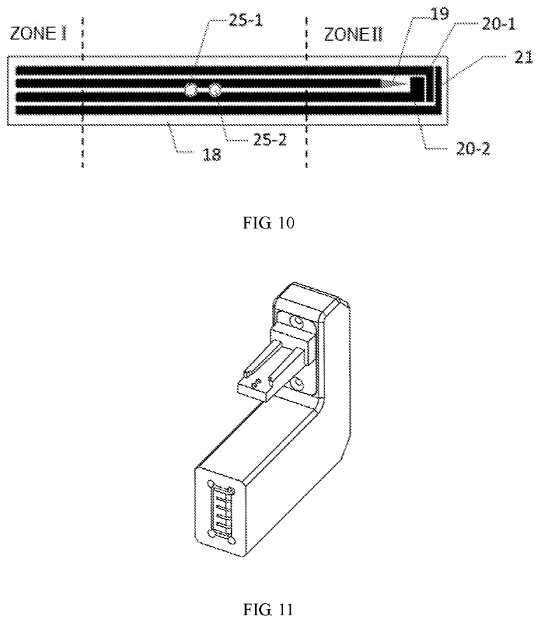

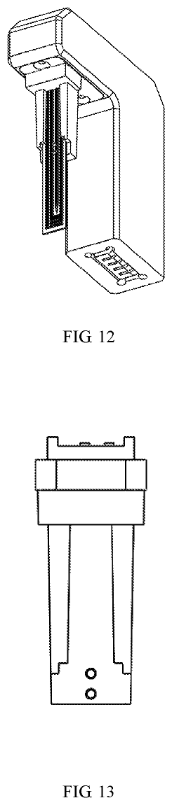

In some embodiments, as shown in FIGS. 10 to 13, the PET substrate 18 of the electrode may be provided with a first locating hole 25-1 and a second locating hole 25-2 penetrating therethrough. The electrode guide groove may be provided with corresponding locating projections matching with the first and the second locating holes. When installing the electrode, the locating projections pass through two locating holes to locate the electrode.

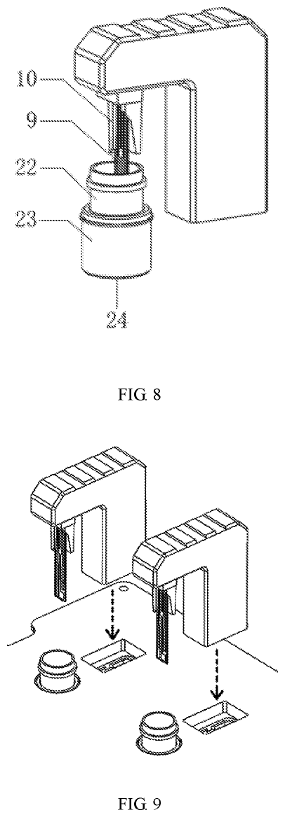

In some embodiments, as shown in FIG. 8, the stirring device includes a stirring barrel 23, a reaction cell 22 and a drive motor 24. The drive motor 24 is embedded in the housing of the main machine and disposed at the bottom of the stirring barrel. The drive motor is a rotating motor or an eccentric motor. The drive motor is configured to drive the stirring barrel to rotate or vibrate quickly. The reaction cell is detachably disposed in the stirring barrel, and follows the rotation or vibration of the stirring barrel during detection.

In some embodiments, the drive motor is a rotating motor. The rotating motor is embedded in the housing of the main machine and disposed at the bottom of a rotating seat of the stirring barrel. A certain offset exists between a rotating shaft of the rotating motor and an axis of the rotating seat. The rotating motor is configured to drive the rotating seat to rotate and swing rapidly. The reaction cell is detachably disposed in the rotating seat, and follows the rotation and swinging of the rotating seat around the axis during detection. This rotation mode helps to improve the stirring efficiency.

In some embodiments, the heavy metal detector adopts a dual-channel detection mode, and its core controls are distributed in a view layer, a controller, and a model layer. The view layer is composed of a touch screen and client software. The user can configure parameters of an upper computer in the view layer, change a detection mode, control a detection process and obtain a final result. The controller includes a master control module and a plurality of sub-control modules. The controller assigns work tasks to the model layer according to instructions issued by the view layer to be executed by a plurality of lower computers. The master control module completes a routing function in accordance with the serial communication protocol, and detection processes of the channels are individually controlled by specific sub-control modules without interfering with each other, ensuring that synchronous detection and asynchronous detection requirements are supported.

In some embodiments, the detection process of a dual-channel or multi-channel heavy metal detector is as follows:

Startup: the power switch button of the instrument is clicked, the running indicator lights up, the LCD touch screen displays an interactive interface, and it is prompted through voice that the instrument is on.

Detection initialization configuration: the reference limit, sample number, sample type, detection time, channel selection, detection mode selection, submission unit, detection personnel information and other parameters are set.

Electrode activation: the electrode activation mode is selected, the two electrode plugs are taken out, a SPE is placed in an electrode socket (i.e., a plug interface of the electrode plug) and the electrode plugs are returned to the original position, and at the same time a certain amount of activator is injected into the two reaction cells with the guarantee that the liquid level is above the reaction zone at the bottom of the SPE, the start button on the interactive interface is clicked, and the stirring device starts up.

Sample detection: a sample detection mode is selected, a certain amount of sample solution under test is injected into the two reaction cells, the start button on the interactive interface is clicked, and the stirring device starts up to enter the detection process.

Completion of detection: the sample solution under test undergoes an electrochemical reaction on the surface of the SPE, the online detection system draws the characteristic electrical signal curve output by the control system on the LCD touch screen so as to display various test results of the tested sample, and it is prompted through voice that the detection is complete.

The beneficial effects can be illustrated through following experimental data:

A guide groove is provided at the end of the electrode socket to limit the insertion position of the SPE in both the horizontal and vertical directions to ensure a constant position of the electrode reaction zone during detection, that is, it is always disposed in the central area of the reaction cell. The connection between the electrode plug and the instrument is changed to a separate plug-in connection, which fixes the electrode immersion depth and facilitates the plug-in operation of the electrode, improving the detection accuracy and stability as a whole.

Cadmium element detection data is used as an example in the following to compare and analyze the performance of the instrument before and after the improvement:

(1) Instrument stability test data before the improvement

Under the control of the same ambient temperature and humidity, testers A, B, C, and D use unimproved heavy metal detectors 1 #, 2 #, 3 #, 4 #, and 5 # to perform instrument stability test. The test method is to define various parameters for instruction detection and use the same batch of SPEs. Each tester tests a 5 ppb standard single element solution of cadmium 20 times, and calculates a relative standard deviation (RSD) of each group of 20 pieces of detection data. The results are shown in the following table:

TABLE 1
Detection data of instrument stability test before the improvement from tester A and B

| | Current/μA | | | | | | | | | |
|---|---|---|---|---|---|---|---|---|---|---|
| | Tester A | | | | | Tester B | | | | |
| | Instrument No. | | | | | | | | | |
| Test No. | 1# | 2# | 3# | 4# | 5# | 1# | 2# | 3# | 4# | 5# |
| 1 | 0.4401 | 0.5171 | 0.5521 | 0.5143 | 0.6644 | 0.5821 | 0.3974 | 0.4349 | 0.4686 | 0.4152 |
| 2 | 0.4215 | 0.4039 | 0.5120 | 0.4143 | 0.4363 | 0.5547 | 0.4320 | 0.3901 | 0.5124 | 0.5295 |
| 3 | 0.5401 | 0.5302 | 0.5152 | 0.5857 | 0.4165 | 0.6578 | 0.4726 | 0.5459 | 0.5238 | 0.3889 |
| 4 | 0.6013 | 0.6028 | 0.5321 | 0.5857 | 0.5355 | 0.5260 | 0.4337 | 0.4563 | 0.5043 | 0.6338 |
| 5 | 0.5975 | 0.5024 | 0.4607 | 0.4140 | 0.6843 | 0.5080 | 0.4695 | 0.4651 | 0.4784 | 0.5423 |
| 6 | 0.7204 | 0.5504 | 0.5312 | 0.5286 | 0.5851 | 0.4279 | 0.4939 | 0.4940 | 0.4524 | 0.6864 |
| 7 | 0.6653 | 0.5037 | 0.6107 | 0.4857 | 0.7140 | 0.4332 | 0.5025 | 0.4385 | 0.4232 | 0.3391 |
| 8 | 0.5298 | 0.6034 | 0.5429 | 0.5714 | 0.6545 | 0.4937 | 0.4807 | 0.4313 | 0.5076 | 0.6106 |
| 9 | 0.4936 | 0.6124 | 0.5624 | 0.5857 | 0.5156 | 0.4912 | 0.4093 | 0.4922 | 0.5238 | 0.6848 |
| 10 | 0.6452 | 0.5387 | 0.6546 | 0.6025 | 0.4165 | 0.4895 | 0.5081 | 0.5047 | 0.4054 | 0.4400 |
| 11 | 0.6578 | 0.5650 | 0.5034 | 0.5429 | 0.6148 | 0.6446 | 0.4601 | 0.4922 | 0.4643 | 0.4384 |
| 12 | 0.6042 | 0.4463 | 0.4513 | 0.5012 | 0.6744 | 0.3643 | 0.4869 | 0.4636 | 0.4800 | 0.3627 |
| 13 | 0.7034 | 0.4507 | 0.4508 | 0.4543 | 0.6545 | 0.7336 | 0.5354 | 0.4725 | 0.4654 | 0.7091 |
| 14 | 0.7012 | 0.5071 | 0.4937 | 0.5213 | 0.7339 | 0.5335 | 0.4286 | 0.4351 | 0.5027 | 0.5392 |
| 15 | 0.7608 | 0.5103 | 0.4819 | 0.5428 | 0.7141 | 0.3694 | 0.5114 | 0.4045 | 0.5075 | 0.4710 |
| 16 | 0.3901 | 0.4525 | 0.4582 | 0.5429 | 0.3570 | 0.3910 | 0.4347 | 0.4403 | 0.4422 | 0.4602 |
| 17 | 0.3804 | 0.4600 | 0.4801 | 0.4289 | 0.5950 | 0.7167 | 0.5203 | 0.4259 | 0.4765 | 0.7384 |
| 18 | 0.4947 | 0.4013 | 0.4919 | 0.4428 | 0.5454 | 0.3692 | 0.5132 | 0.4886 | 0.5676 | 0.5221 |
| 19 | 0.7031 | 0.4152 | 0.4138 | 0.4571 | 0.5851 | 0.5345 | 0.473 | 0.4361 | 0.5335 | 0.4493 |
| 20 | 0.6742 | 0.4702 | 0.4913 | 0.4286 | 0.7239 | 0.4507 | 0.5679 | 0.4349 | 0.4930 | 0.4897 |
| AV | 0.5862 | 0.5022 | 0.5095 | 0.5075 | 0.5910 | 0.5136 | 0.4766 | 0.4573 | 0.4866 | 0.5225 |
| SD | 0.1149 | 0.0631 | 0.0555 | 0.0616 | 0.1115 | 0.1080 | 0.0432 | 0.0366 | 0.0380 | 0.1164 |
| RSD | 19.6% | 12.6% | 10.9% | 12.1% | 18.9% | 21.0% | 9.1% | 8.0% | 7.8% | 22.3% |

TABLE 2
Detection data of instrument stability test before the improvement from tester C and D

| | Current/μA | | | | | | | | | |
|---|---|---|---|---|---|---|---|---|---|---|
| | Tester C | | | | | Tester D | | | | |
| | Instrument No. | | | | | | | | | |
| Test No. | 1# | 2# | 3# | 4# | 5# | 1# | 2# | 3# | 4# | 5# |
| 1 | 0.4084 | 0.4944 | 0.4049 | 0.3707 | 0.4429 | 0.3884 | 0.4533 | 0.4807 | 0.3911 | 0.4858 |
| 2 | 0.6564 | 0.4343 | 0.4599 | 0.3947 | 0.5269 | 0.3924 | 0.3839 | 0.4301 | 0.4245 | 0.6339 |
| 3 | 0.3746 | 0.5142 | 0.4551 | 0.5231 | 0.4867 | 0.6686 | 0.3567 | 0.5031 | 0.5091 | 0.5866 |
| 4 | 0.5068 | 0.5023 | 0.4810 | 0.4974 | 0.4314 | 0.4715 | 0.5145 | 0.5469 | 0.5613 | 0.4788 |
| 5 | 0.4137 | 0.4972 | 0.4637 | 0.4909 | 0.5392 | 0.7053 | 0.5268 | 0.5596 | 0.5964 | 0.5733 |
| 6 | 0.6169 | 0.4504 | 0.4211 | 0.4914 | 0.6825 | 0.6736 | 0.4906 | 0.5486 | 0.5626 | 0.5810 |
| 7 | 0.5538 | 0.4608 | 0.4901 | 0.5192 | 0.7349 | 0.5380 | 0.5023 | 0.5458 | 0.5598 | 0.3035 |
| 8 | 0.5934 | 0.4912 | 0.4457 | 0.4384 | 0.4483 | 0.6077 | 0.5004 | 0.4095 | 0.4851 | 0.3439 |
| 9 | 0.5038 | 0.5224 | 0.4083 | 0.5291 | 0.6810 | 0.4968 | 0.5267 | 0.5276 | 0.4056 | 0.4637 |
| 10 | 0.4694 | 0.4704 | 0.5136 | 0.4971 | 0.4476 | 0.7141 | 0.5178 | 0.4844 | 0.4957 | 0.4009 |
| 11 | 0.4347 | 0.5632 | 0.4768 | 0.5374 | 0.4561 | 0.4483 | 0.4377 | 0.5457 | 0.5524 | 0.4384 |
| 12 | 0.4436 | 0.4528 | 0.4799 | 0.5378 | 0.5593 | 0.4856 | 0.5144 | 0.5344 | 0.5120 | 0.5530 |
| 13 | 0.6360 | 0.4592 | 0.4813 | 0.4710 | 0.6902 | 0.4804 | 0.5298 | 0.5378 | 0.4821 | 0.5395 |
| 14 | 0.4128 | 0.4244 | 0.5406 | 0.5103 | 0.5361 | 0.7100 | 0.5136 | 0.3971 | 0.5032 | 0.4107 |
| 15 | 0.3804 | 0.4176 | 0.5468 | 0.4966 | 0.4684 | 0.3953 | 0.5462 | 0.3996 | 0.4154 | 0.6272 |
| 16 | 0.7168 | 0.4880 | 0.5053 | 0.4957 | 0.4576 | 0.3905 | 0.4388 | 0.4231 | 0.5177 | 0.5868 |
| 17 | 0.6414 | 0.4428 | 0.4208 | 0.5019 | 0.7372 | 0.5509 | 0.4521 | 0.4345 | 0.4904 | 0.4249 |
| 18 | 0.4310 | 0.4528 | 0.5435 | 0.4338 | 0.4992 | 0.5211 | 0.5123 | 0.5069 | 0.5629 | 0.5194 |
| 19 | 0.5345 | 0.4320 | 0.3987 | 0.4563 | 0.4468 | 0.5164 | 0.6112 | 0.4395 | 0.5022 | 0.4587 |
| 20 | 0.5993 | 0.4416 | 0.4461 | 0.4099 | 0.5146 | 0.5194 | 0.5708 | 0.4171 | 0.4647 | 0.3579 |
| AV | 0.5164 | 0.4706 | 0.4692 | 0.4801 | 0.5393 | 0.5337 | 0.4950 | 0.4836 | 0.4997 | 0.4884 |
| SD | 0.1019 | 0.0366 | 0.0445 | 0.0468 | 0.1027 | 0.1086 | 0.0586 | 0.0572 | 0.0563 | 0.0941 |
| RSD | 19.7% | 7.8% | 9.5% | 9.8% | 19.1% | 20.3% | 11.8% | 11.8% | 11.3% | 19.3% |

TABLE 3
Comparison list of instrument stability
test data before the improvement

| | Test instrument | | | | | |
|---|---|---|---|---|---|---|
| Tester | 1# | 2# | 3# | 4# | 5# | Average |
| Tester A | 19.6% | 12.6% | 10.9% | 12.1% | 18.9% | 14.8% |
| Tester B | 21.0% | 9.1% | 8.0% | 7.8% | 22.3% | 13.6% |
| Tester C | 19.7% | 7.8% | 9.5% | 9.8% | 19.1% | 13.2% |
| Tester D | 20.3% | 11.8% | 11.8% | 11.3% | 19.3% | 14.9% |

From the above data, it is found that the relative standard deviations of the detection data measured by different testers using the 1 # and 5 # instruments are significantly higher than those of other instruments. After careful inspection, it is found that the electrode socket of the instrument is loose and the electrode inserted is easy to tilt. This situation has increased the influence of electrode insertion method and angle on the stability of test results. Comparing the relative standard deviations of the detection data measured by different testers using the 2 #, 3 # and 4 # instruments, it is found that the stability of the testers' detection results is: B>C>A and D.

(2) Analysis of Stability Test Data after Adding an Electrode Guide Groove to the Instrument

Under the same ambient temperature and humidity, testers A, B, C, D use heavy metal detectors 1 #, 2 #, 3 #, 4 #, and 5 # with an electrode socket (a locating device is added) to perform instrument stability test. The test method is to define various parameters for instrument detection and use the same batch of SPEs (electrode batch: NA07-1, round working electrode). Each tester tests a 5 ppb standard single element solution of cadmium 20 times, and calculates a relative standard deviation of each group of 20 pieces of detection data. The results are shown in the following table:

TABLE 4
Test data of instrument stability test after electrode locating from tester A and B

| | Current/μA | | | | | | | | | |
|---|---|---|---|---|---|---|---|---|---|---|
| | Tester A | | | | | Tester B | | | | |
| | Instrument No. | | | | | | | | | |
| Test No. | 1# | 2# | 3# | 4# | 5# | 1# | 2# | 3# | 4# | 5# |
| 1 | 0.4545 | 0.4395 | 0.4517 | 0.4380 | 0.4156 | 0.4483 | 0.4744 | 0.4556 | 0.4604 | 0.4573 |
| 2 | 0.4600 | 0.3954 | 0.4026 | 0.5946 | 0.4827 | 0.4742 | 0.4208 | 0.4848 | 0.4422 | 0.3858 |
| 3 | 0.4466 | 0.4195 | 0.4921 | 0.4318 | 0.4699 | 0.4564 | 0.4569 | 0.4615 | 0.4735 | 0.4271 |
| 4 | 0.4629 | 0.3868 | 0.3935 | 0.4521 | 0.4661 | 0.4564 | 0.4192 | 0.4651 | 0.4655 | 0.4001 |
| 5 | 0.4988 | 0.4287 | 0.4124 | 0.3317 | 0.3917 | 0.5132 | 0.4540 | 0.5042 | 0.4604 | 0.4414 |
| 6 | 0.5244 | 0.4607 | 0.4825 | 0.4257 | 0.3602 | 0.4778 | 0.4772 | 0.4849 | 0.4876 | 0.4430 |
| 7 | 0.4108 | 0.4923 | 0.5464 | 0.4114 | 0.3849 | 0.4689 | 0.4859 | 0.4753 | 0.4871 | 0.3137 |
| 8 | 0.4866 | 0.5293 | 0.4266 | 0.4162 | 0.3679 | 0.4671 | 0.4641 | 0.4345 | 0.4204 | 0.4938 |
| 9 | 0.4953 | 0.4389 | 0.4059 | 0.4537 | 0.3865 | 0.4493 | 0.4216 | 0.4552 | 0.4397 | 0.4398 |
| 10 | 0.5345 | 0.5399 | 0.4413 | 0.4396 | 0.4623 | 0.4671 | 0.4917 | 0.4126 | 0.4528 | 0.4482 |
| 11 | 0.5059 | 0.5319 | 0.4378 | 0.5085 | 0.4153 | 0.4796 | 0.4453 | 0.4354 | 0.4687 | 0.6558 |
| 12 | 0.5462 | 0.4590 | 0.5065 | 0.4306 | 0.6927 | 0.4403 | 0.4700 | 0.4453 | 0.4403 | 0.6654 |
| 13 | 0.4113 | 0.4140 | 0.4186 | 0.4772 | 0.6812 | 0.5295 | 0.5178 | 0.5044 | 0.4604 | 0.4779 |
| 14 | 0.3952 | 0.4169 | 0.4777 | 0.4475 | 0.6366 | 0.4439 | 0.4816 | 0.4552 | 0.4771 | 0.4587 |
| 15 | 0.3732 | 0.4489 | 0.5208 | 0.4103 | 0.4934 | 0.4635 | 0.4946 | 0.4175 | 0.4588 | 0.5589 |
| 16 | 0.4292 | 0.4145 | 0.4745 | 0.3865 | 0.5785 | 0.5027 | 0.5065 | 0.5047 | 0.4702 | 0.4752 |
| 17 | 0.5143 | 0.4989 | 0.4825 | 0.5473 | 0.6385 | 0.4760 | 0.5034 | 0.4849 | 0.4729 | 0.692 |
| 18 | 0.3981 | 0.5272 | 0.4586 | 0.4600 | 0.4933 | 0.4403 | 0.4961 | 0.4453 | 0.4765 | 0.7084 |
| 19 | 0.4111 | 0.4425 | 0.4506 | 0.4553 | 0.4168 | 0.4617 | 0.4670 | 0.4651 | 0.4604 | 0.4001 |
| 20 | 0.5093 | 0.4126 | 0.5640 | 0.5422 | 0.4143 | 0.4671 | 0.5083 | 0.4478 | 0.4638 | 0.4684 |
| AV | 0.4634 | 0.4549 | 0.4623 | 0.4530 | 0.4824 | 0.4692 | 0.4728 | 0.4620 | 0.4619 | 0.4906 |
| SD | 0.0509 | 0.0472 | 0.0466 | 0.0578 | 0.1037 | 0.0229 | 0.0289 | 0.0264 | 0.0163 | 0.1061 |
| RSD | 11.0% | 10.4% | 10.1% | 12.8% | 21.5% | 4.9% | 6.1% | 5.7% | 3.5% | 21.6% |

TABLE 5
Test data of instrument stability test after electrode locating from tester C and D

| | Current/μA | | | | | | | | | |
|---|---|---|---|---|---|---|---|---|---|---|
| | Tester C | | | | | Tester D | | | | |
| | Instrument No. | | | | | | | | | |
| Test No. | 1# | 2# | 3# | 4# | 5# | 1# | 2# | 3# | 4# | 5# |
| 1 | 0.5237 | 0.5201 | 0.5302 | 0.4822 | 0.4726 | 0.4884 | 0.4248 | 0.5152 | 0.4762 | 0.6237 |
| 2 | 0.5131 | 0.4627 | 0.5227 | 0.4658 | 0.5678 | 0.4902 | 0.4627 | 0.4563 | 0.4701 | 0.618 |
| 3 | 0.5331 | 0.4842 | 0.5013 | 0.483 | 0.5226 | 0.4964 | 0.4786 | 0.4495 | 0.4786 | 0.5745 |
| 4 | 0.4962 | 0.5235 | 0.4435 | 0.4414 | 0.6609 | 0.5113 | 0.4515 | 0.4592 | 0.4571 | 0.4413 |
| 5 | 0.4238 | 0.4634 | 0.4805 | 0.4521 | 0.6504 | 0.4658 | 0.5006 | 0.4594 | 0.4882 | 0.4065 |
| 6 | 0.4684 | 0.4529 | 0.4101 | 0.4517 | 0.4210 | 0.5130 | 0.5246 | 0.4588 | 0.4041 | 0.3772 |
| 7 | 0.5008 | 0.4553 | 0.3928 | 0.4215 | 0.4049 | 0.4195 | 0.4908 | 0.4671 | 0.4701 | 0.3731 |
| 8 | 0.4761 | 0.4834 | 0.4369 | 0.4508 | 0.4887 | 0.4833 | 0.4887 | 0.5017 | 0.4419 | 0.4261 |
| 9 | 0.4469 | 0.5017 | 0.5076 | 0.4828 | 0.4533 | 0.5342 | 0.4633 | 0.4317 | 0.4532 | 0.3998 |
| 10 | 0.4715 | 0.4484 | 0.4668 | 0.4847 | 0.4484 | 0.5233 | 0.4289 | 0.4557 | 0.4638 | 0.4231 |
| 11 | 0.4907 | 0.4623 | 0.5396 | 0.4633 | 0.4742 | 0.4568 | 0.4364 | 0.4812 | 0.4715 | 0.6602 |
| 12 | 0.4392 | 0.4911 | 0.4734 | 0.4708 | 0.4452 | 0.4740 | 0.4225 | 0.4400 | 0.4721 | 0.5015 |
| 13 | 0.4592 | 0.5087 | 0.4446 | 0.483 | 0.4194 | 0.4559 | 0.5211 | 0.4986 | 0.4679 | 0.4139 |
| 14 | 0.4607 | 0.3673 | 0.4964 | 0.4645 | 0.5975 | 0.4543 | 0.4798 | 0.4600 | 0.4614 | 0.5964 |
| 15 | 0.4530 | 0.4529 | 0.4372 | 0.4761 | 0.4855 | 0.4886 | 0.4564 | 0.5031 | 0.4646 | 0.3949 |
| 16 | 0.4546 | 0.4581 | 0.4451 | 0.4845 | 0.4162 | 0.4458 | 0.4223 | 0.5025 | 0.5162 | 0.4124 |
| 17 | 0.4838 | 0.3613 | 0.4709 | 0.4828 | 0.3952 | 0.4980 | 0.5442 | 0.4610 | 0.5093 | 0.5202 |
| 18 | 0.5051 | 0.4329 | 0.4868 | 0.4809 | 0.3984 | 0.4844 | 0.4877 | 0.4828 | 0.5490 | 0.5707 |
| 19 | 0.5855 | 0.5012 | 0.4667 | 0.4622 | 0.4145 | 0.4761 | 0.5407 | 0.4209 | 0.4803 | 0.4134 |
| 20 | 0.4375 | 0.5089 | 0.4742 | 0.5120 | 0.4807 | 0.5054 | 0.4759 | 0.4913 | 0.4406 | 0.4275 |
| AV | 0.4811 | 0.4670 | 0.4714 | 0.4698 | 0.4809 | 0.4832 | 0.4751 | 0.4698 | 0.4718 | 0.4787 |
| SD | 0.0378 | 0.0426 | 0.0377 | 0.0194 | 0.0785 | 0.0274 | 0.0373 | 0.0254 | 0.0292 | 0.0921 |
| RSD | 7.8% | 9.1% | 8.0% | 4.1% | 16.3% | 5.7% | 7.9% | 5.4% | 6.2% | 19.2% |

TABLE 6
Instrument stability test data list after electrode locating

| | Test instrument | | | | | |
|---|---|---|---|---|---|---|
| Tester | 1# | 2# | 3# | 4# | 5# | Average |
| Tester A | 11.0% | 10.4% | 10.1% | 12.8% | 21.5% | 11.0% |
| Tester B | 4.9% | 6.1% | 5.7% | 3.5% | 21.6% | 5.0% |
| Tester C | 7.8% | 9.1% | 8.0% | 4.1% | 16.3% | 7.2% |
| Tester D | 5.7% | 7.9% | 5.4% | 6.2% | 19.2% | 6.3% |

From the above data, it is found that after an electrode locating device is added, the relative standard deviations of the detection data measured by different testers except for the 5 # instrument are significantly reduced, but the relative standard deviations of the detection data measured by different testers using the 1 #, 2 #, 3 # and 4 # instruments are still different, and the stability of the detection results is: B>D>C>A. After inspection, it is found that compared with the other 4 instruments, the lifting operation of a lifting rod of an electrode socket in the 5 # instrument is not smooth, and there is a phenomenon of inconsistent pressing positions for a plurality of operations, resulting in a difference in the liquid immersion depth of the electrode working zone, which affects the stability of the test results.

(3) Analysis of stability test data after adding a locating device to the electrode socket and adopting a plug-in connection between the electrode plug and the instrument

The 1 #, 2 #, 3 #, 4 #, 5 # heavy metal detectors were further improved, and a locating device was added to the electrode socket while the electrode plug was connected to the instrument in a plug-in fashion. Testers A, B, C, and D carry out instrument stability test. The test method is to: under the control of the same ambient temperature and humidity, define various parameters for instrument detection and use the same batch of SPEs (electrode batch: NA07-1, round working electrode). Each tester tests a 5 ppb standard single element solution of cadmium 20 times, and calculates a relative standard deviation of each group of 20 pieces of detection data. The results are shown in the following table:

TABLE 7
Test data of instrument stability test with electrode locating
and pluggable electrode plug from tester A and B

| | Current/μA | | | | | | | | | |
|---|---|---|---|---|---|---|---|---|---|---|
| | Tester A | | | | | Tester B | | | | |
| | Instrument No. | | | | | | | | | |
| Test No. | 1# | 2# | 3# | 4# | 5# | 1# | 2# | 3# | 4# | 5# |
| 1 | 0.4675 | 0.4709 | 0.4666 | 0.4317 | 0.4713 | 0.4661 | 0.4598 | 0.4467 | 0.4632 | 0.4576 |
| 2 | 0.5027 | 0.4761 | 0.4534 | 0.4499 | 0.5041 | 0.4803 | 0.5027 | 0.4992 | 0.4871 | 0.4843 |
| 3 | 0.4695 | 0.4801 | 0.4867 | 0.4737 | 0.4734 | 0.4719 | 0.4956 | 0.4786 | 0.4904 | 0.4642 |
| 4 | 0.4929 | 0.4981 | 0.5008 | 0.4976 | 0.4883 | 0.4744 | 0.4948 | 0.4574 | 0.5081 | 0.4815 |
| 5 | 0.4812 | 0.5094 | 0.4728 | 0.4782 | 0.4917 | 0.4689 | 0.4693 | 0.5013 | 0.4904 | 0.5246 |
| 6 | 0.5203 | 0.5046 | 0.4967 | 0.4979 | 0.4620 | 0.4411 | 0.4439 | 0.5025 | 0.5019 | 0.5344 |
| 7 | 0.5008 | 0.4782 | 0.4605 | 0.4803 | 0.4757 | 0.4828 | 0.4452 | 0.4904 | 0.4722 | 0.4854 |
| 8 | 0.4496 | 0.4856 | 0.4766 | 0.4897 | 0.4982 | 0.4803 | 0.4979 | 0.4423 | 0.4689 | 0.4870 |
| 9 | 0.4548 | 0.4386 | 0.4887 | 0.4703 | 0.4976 | 0.4729 | 0.4839 | 0.5059 | 0.4854 | 0.4382 |
| 10 | 0.4675 | 0.4377 | 0.4565 | 0.4675 | 0.4765 | 0.4835 | 0.4977 | 0.4508 | 0.4689 | 0.4985 |
| 11 | 0.4929 | 0.4794 | 0.4847 | 0.4634 | 0.4845 | 0.4937 | 0.4659 | 0.4831 | 0.4012 | 0.4821 |
| 12 | 0.4871 | 0.4959 | 0.4827 | 0.4906 | 0.4896 | 0.5041 | 0.4709 | 0.4778 | 0.4821 | 0.4691 |
| 13 | 0.4851 | 0.4653 | 0.4746 | 0.4917 | 0.4879 | 0.4979 | 0.4566 | 0.4857 | 0.4706 | 0.4625 |
| 14 | 0.4616 | 0.4856 | 0.4809 | 0.4731 | 0.4943 | 0.4524 | 0.4932 | 0.484 | 0.5035 | 0.4887 |
| 15 | 0.5242 | 0.4717 | 0.4908 | 0.4754 | 0.5019 | 0.4914 | 0.4979 | 0.4876 | 0.4706 | 0.4694 |
| 16 | 0.4988 | 0.5112 | 0.4037 | 0.4471 | 0.4861 | 0.5011 | 0.4945 | 0.5081 | 0.5052 | 0.5001 |
| 17 | 0.5360 | 0.5094 | 0.4706 | 0.4609 | 0.4859 | 0.4798 | 0.4984 | 0.4903 | 0.4986 | 0.4908 |
| 18 | 0.5223 | 0.4911 | 0.4947 | 0.4891 | 0.4878 | 0.5057 | 0.5068 | 0.4475 | 0.5003 | 0.4989 |
| 19 | 0.5086 | 0.4782 | 0.4928 | 0.4816 | 0.4735 | 0.4809 | 0.5034 | 0.4741 | 0.4706 | 0.4976 |
| 20 | 0.4988 | 0.4654 | 0.4729 | 0.4550 | 0.4927 | 0.4643 | 0.4836 | 0.4681 | 0.4408 | 0.4593 |
| AV | 0.4911 | 0.4816 | 0.4754 | 0.4732 | 0.4862 | 0.4797 | 0.4831 | 0.4791 | 0.4790 | 0.4837 |
| SD | 0.0237 | 0.0202 | 0.0210 | 0.0175 | 0.0108 | 0.0163 | 0.0195 | 0.0203 | 0.0246 | 0.0222 |
| RSD | 4.8% | 4.2% | 4.4% | 3.7% | 2.2% | 3.4% | 4.0% | 4.2% | 5.1% | 4.6% |

TABLE 8
Test data of instrument stability test with electrode locating
and pluggable electrode plug from tester C and D

| | Current/μA | | | | | | | | | |
|---|---|---|---|---|---|---|---|---|---|---|
| | Tester C | | | | | Tester D | | | | |
| | Instrument No. | | | | | | | | | |
| Test No. | 1# | 2# | 3# | 4# | 5# | 1# | 2# | 3# | 4# | 5# |
| 1 | 0.5059 | 0.4532 | 0.4829 | 0.4716 | 0.5401 | 0.4909 | 0.4849 | 0.4611 | 0.4668 | 0.4409 |
| 2 | 0.4965 | 0.4933 | 0.5072 | 0.4864 | 0.5341 | 0.4676 | 0.4967 | 0.4469 | 0.4850 | 0.4654 |
| 3 | 0.4808 | 0.4491 | 0.4772 | 0.4677 | 0.5078 | 0.4926 | 0.5037 | 0.5109 | 0.5455 | 0.5164 |
| 4 | 0.4984 | 0.4944 | 0.4546 | 0.4521 | 0.5045 | 0.4909 | 0.4817 | 0.5008 | 0.4846 | 0.5061 |
| 5 | 0.4928 | 0.4757 | 0.4755 | 0.4783 | 0.5049 | 0.4776 | 0.5085 | 0.4830 | 0.4618 | 0.4883 |
| 6 | 0.4471 | 0.4907 | 0.4745 | 0.4865 | 0.5041 | 0.4859 | 0.4984 | 0.4871 | 0.4884 | 0.4676 |
| 7 | 0.4752 | 0.5353 | 0.4598 | 0.5165 | 0.4936 | 0.5159 | 0.5046 | 0.5352 | 0.4710 | 0.5001 |
| 8 | 0.5088 | 0.4648 | 0.5319 | 0.4939 | 0.4997 | 0.4543 | 0.5072 | 0.4613 | 0.4719 | 0.4809 |
| 9 | 0.4901 | 0.4808 | 0.4989 | 0.4744 | 0.5057 | 0.4793 | 0.4876 | 0.5356 | 0.4894 | 0.5053 |
| 10 | 0.4783 | 0.4895 | 0.4806 | 0.4931 | 0.4798 | 0.4776 | 0.5098 | 0.4884 | 0.4708 | 0.5001 |
| 11 | 0.4812 | 0.4852 | 0.4513 | 0.5053 | 0.4758 | 0.4714 | 0.5051 | 0.4796 | 0.4781 | 0.4509 |
| 12 | 0.4513 | 0.5136 | 0.4976 | 0.4735 | 0.4778 | 0.5057 | 0.4971 | 0.5054 | 0.4905 | 0.4839 |
| 13 | 0.4927 | 0.5094 | 0.4756 | 0.4888 | 0.4968 | 0.4743 | 0.4977 | 0.4895 | 0.4426 | 0.5075 |
| 14 | 0.4252 | 0.4811 | 0.5048 | 0.4973 | 0.4932 | 0.4476 | 0.5086 | 0.4792 | 0.4788 | 0.4897 |
| 15 | 0.4989 | 0.4916 | 0.5002 | 0.4811 | 0.4881 | 0.5049 | 0.4918 | 0.4938 | 0.4899 | 0.4735 |
| 16 | 0.5096 | 0.4764 | 0.4420 | 0.4925 | 0.4657 | 0.5026 | 0.5070 | 0.4856 | 0.4813 | 0.4824 |
| 17 | 0.5071 | 0.4776 | 0.5262 | 0.4716 | 0.4978 | 0.4593 | 0.4866 | 0.4712 | 0.4813 | 0.4705 |
| 18 | 0.4848 | 0.4878 | 0.4655 | 0.5063 | 0.4826 | 0.5043 | 0.5043 | 0.4492 | 0.4905 | 0.4513 |
| 19 | 0.4859 | 0.4854 | 0.4967 | 0.4648 | 0.4936 | 0.4851 | 0.4904 | 0.4768 | 0.4482 | 0.4587 |
| 20 | 0.4882 | 0.4897 | 0.4828 | 0.4101 | 0.4857 | 0.4743 | 0.4916 | 0.4551 | 0.4553 | 0.4898 |
| AV | 0.4849 | 0.4862 | 0.4843 | 0.4806 | 0.4966 | 0.4831 | 0.4982 | 0.4848 | 0.4786 | 0.4815 |
| SD | 0.0213 | 0.0189 | 0.0232 | 0.0223 | 0.0175 | 0.0179 | 0.0087 | 0.0241 | 0.0207 | 0.0207 |
| RSD | 4.4% | 3.9% | 4.8% | 4.6% | 3.5% | 3.7% | 1.7% | 5.0% | 4.3% | 4.3% |

TABLE 9
Test data list of instrument stability test with
electrode locating and pluggable electrode plug

| | Test instrument | | | | | |
|---|---|---|---|---|---|---|
| Tester | 1# | 2# | 3# | 4# | 5# | Average |
| Tester A | 4.8% | 4.2% | 4.4% | 3.7% | 2.2% | 4.3% |
| Tester B | 3.4% | 4.0% | 4.2% | 5.1% | 4.6% | 4.2% |
| Tester C | 4.4% | 3.9% | 4.8% | 4.6% | 3.5% | 4.4% |
| Tester D | 3.7% | 1.7% | 5.0% | 4.3% | 4.3% | 3.7% |

From the above data, it is found that the stability of the instrument is further enhanced after the addition of the locating device and the use of the plug-in connection. The relative standard deviation of each group of data is basically controlled below 5.0%, preferably 1.7%, such instrument has good stability, and the different testers has no significant impact on the stability of the detection. This shows that the addition of the locating device and the use of the plug-in connection can significantly improve the stability of the detection results, reduce personnel operating errors, and advantageously improve the on-site adaptability of the instrument.

2. The design of the shape and structure of the working zone of the SPE improves the sensitivity, stability and current signal strength of the detection.

1 #, 2 #, 3 #, 4 #, and 5 # heavy metal detectors with electrode locating and pluggable electrode plug are adopted, SPEs with working electrodes optimized (electrode batch: NA08-1, square working electrode) are adopted, under the control of the same ambient temperature and humidity, a 5 ppb standard single element solution of cadmium is tested 20 times, and a relative standard deviation of each group of 20 pieces of detection data is calculated. The results are shown in the following table:

TABLE 10
Comparison of different working electrode patterns vs. current signal

| Working | Results of this method/(μA) | | | | | | | | Coefficient of |
|---|---|---|---|---|---|---|---|---|---|
| electrode shape | 1 | 2 | 3 | 4 | 5 | 6 | 7 | Average | Variation/% |

Determination of lead (Pb) content

| | | | | | | | | | |
|---|---|---|---|---|---|---|---|---|---|
| Square | 0.27 | 0.25 | 0.24 | 0.28 | 0.24 | 0.21 | 0.22 | 0.25 | 8.6 |
| Circular | 0.30 | 0.30 | 0.29 | 0.26 | 0.27 | 0.27 | 0.26 | 0.28 | 6.1 |
| Rectangular | 0.34 | 0.33 | 0.27 | 0.30 | 0.31 | 0.36 | 0.35 | 0.32 | 9.3 |

Determination of cadmium (Cd) content

| | | | | | | | | | |
|---|---|---|---|---|---|---|---|---|---|
| Square | 0.49 | 0.46 | 0.56 | 0.43 | 0.48 | 0.56 | 0.42 | 0.49 | 10.7 |
| Circular | 0.55 | 0.57 | 0.51 | 0.62 | 0.50 | 0.51 | 0.51 | 0.55 | 7.2 |
| Rectangular | 0.67 | 0.79 | 0.68 | 0.62 | 0.55 | 0.59 | 0.78 | 0.67 | 12.5 |

TABLE 11
Comparison of different additions of carbon-based materials vs. current signal

| Adding amount of | | | | | | | | | |
|---|---|---|---|---|---|---|---|---|---|
| carbon-based | | | | | | | | | |
| material in | Results of this method/(μA) | | | | | | | | Coefficient of |
| working electrode | 1 | 2 | 3 | 4 | 5 | 6 | 7 | Average | Variation/% |

Determination of lead (Pb) content

| | | | | | | | | | |
|---|---|---|---|---|---|---|---|---|---|
| <0.3% | 0.21 | 0.21 | 0.21 | 0.20 | 0.21 | 0.20 | 0.25 | 0.21 | 7.3 |
| 0.3%-0.5% | 0.30 | 0.29 | 0.30 | 0.29 | 0.28 | 0.27 | 0.30 | 0.29 | 3.6 |
| >0.5% | 0.21 | 0.20 | 0.18 | 0.19 | 0.19 | 0.19 | 0.19 | 0.19 | 4.3 |

Determination of cadmium (Cd) content

| | | | | | | | | | |
|---|---|---|---|---|---|---|---|---|---|
| <0.3% | 0.40 | 0.41 | 0.42 | 0.42 | 0.41 | 0.40 | 0.42 | 0.40 | 2.0 |
| 0.3%-0.5% | 0.52 | 0.55 | 0.54 | 0.52 | 0.51 | 0.53 | 0.51 | 0.52 | 2.8 |
| >0.5% | 0.39 | 0.40 | 0.40 | 0.39 | 0.40 | 0.39 | 0.41 | 0.39 | 1.7 |

3. Standard Sample Test Data

An instrument with electrode locating and pluggable electrode plug is adopted, SPEs with working electrodes optimized (electrode batch: NA08-1, square working electrode) are adopted, and a trial instrument uses recommended parameters to detect the cadmium content in an actual brown rice sample to detect the accuracy and precision of the test instrument. The detection methods are as follows:

Accuracy detection method: the cadmium content in brown rice flour is detected, physical standard samples of 3 concentration levels are adopted, each concentration level is measured 3 times in parallel, and an average value is taken. A deviation between the detection result and the physical standard sample is calculated.

Calculation method: (Detection average−sample calibration value)/sample calibration value×100%

Precision Measurement Method:

The precision is expressed by a coefficient of variation, the same physical standard sample is measured no less than 6 times, and the coefficient of variation is calculated.

Calculation method of the coefficient of variation: Coefficient of variation=standard deviation/detection mean×100%.

TABLE 12
Detection results of cadmium in brown rice flour samples

| | Standard value | Test value | | | | | Coefficient of |
|---|---|---|---|---|---|---|---|
| Number | (mg/kg) | (mg/kg) | | | Average | Accuracy/% | Variation/% |
| MIETAL-DJTZK-014 | 0.704 ± 0.055 | 0.709 | 0.714 | 0.698 | 0.709 | 0.4 | / |
| GBW (E) 100377 | 0.261 ± 0.020 | 0.265 | 0.276 | 0.268 | 0.269 | 3.4 | 1.3 |
| | | 0.271 | 0.267 | 0.272 | | | |
| GBW (E) 100378 | 0.169 ± 0.015 | 0.171 | 0.170 | 0.169 | 0.170 | 0.6 | / |

The accuracy deviation range is between −10% and +10%, and the precision (coefficient of variation) is ≤10%.

In a possible embodiment, the dual or multi-channel heavy metal detector has a voice prompt function, and prompts a user to standardize the operation for detection abnormalities. Usual abnormal situations are as follows:

1. Insufficient battery life of a heavy metal detector: a battery module cannot supply a circuit module to work normally, prompting the instrument to be charged in time.

2. Abnormal loop: a SPE is not inserted into an electrode socket at the upper end of an electrode plug; a volume of the solution added in a reaction cell is not enough to completely submerge an electrode immersion area; and a hardware circuit connection is interrupted. In view of the above, the user is prompted to check the loop.

3. Invalid detection: dual-channel synchronous accurate detection is applied to the same detection sample. The detection results of the two channels are quite different. If a set threshold is exceeded, it is considered that current detection is wrong and prompts to retest.

The specific embodiments described above further describe the objectives, technical solutions, and beneficial effects of the present disclosure in further detail. It should be understood that the above descriptions are only specific embodiments of the present disclosure, and are not intended to limit the scope of the present disclosure. Any modifications, equivalent replacements, improvements and the like made within a spirit and principle of the present disclosure shall be included in the scope of protection of the present disclosure.

1. A heavy metal detector, comprising a housing having a top cover and a base, and a main machine and an electrolysis module both arranged in the housing, wherein the main machine comprises a main machine circuit, and the main machine circuit comprises a main controller, a power supply module, a signal acquisition and processing module, an electrolysis module interface and a signal conversion module; the main controller being electrically connected to the signal acquisition and processing module, the signal conversion module and the power supply module; the electrolysis module interface being configured to connect the electrolysis module and the signal acquisition and processing module; the signal acquisition and processing module being configured to receive a characteristic electrical signal output by the electrolysis module, and then output a detection result to the main controller; the main controller being configured to display the detection result on a display module; and wherein a plurality of electrolysis module interfaces are provided, and the base is provided with a plurality of electrolysis module installation ports and stirring devices arranged side by side with the electrolysis module installation ports.

2. The heavy metal detector according to claim 1, wherein the electrolysis module comprises an electrode mounting plug and a screen-printed electrode (SPE); the SPE being installed on the electrode mounting plug in a plug-in fashion and electrically connected to the electrolysis module, and the electrode mounting plug being installed on the base in a plug-in fashion and electrically connected to the main machine circuit.

3. The heavy metal detector according to claim 2, wherein the SPE is a double-sided electrode comprising a PET substrate and electrodes arranged in mirror on both sides of the PET substrate; and the electrodes comprising a reference electrode, a working electrode and an auxiliary electrode.

4. The heavy metal detector according to claim 2, wherein the SPE is a dual-working electrode comprising a reference electrode, a first working electrode, a second working electrode and an auxiliary electrode arranged on one side of the PET substrate, and the first working electrode, the second working electrode and the auxiliary electrode being all L-shaped.

5. The heavy metal detector according to claim 2, wherein the electrode mounting plug is provided with a plug interface for installing the SPE, a guide groove is vertically arranged on an outside of the plug interface, and upper and lower ends of the guide groove are open; and the SPE is installed in the plug interface, and partially disposed in the guide groove.

6. The heavy metal detector according to claim 5, wherein the guide groove comprises a first side, a second side and a groove bottom plate, the first side and the second side being respectively disposed on both sides of the groove bottom plate; upper edges of the first side, the second side and the groove bottom plate being flush; and a length of the first side being greater than a length of the groove bottom plate, and the length of the groove bottom plate being greater than a length of the second side.

7. The heavy metal detector according to claim 6, wherein the first side comprises a first side plate provided with a first limiting rib, the first side plate being perpendicular to the groove bottom plate, the first side plate being perpendicular to the first limiting rib, the groove bottom plate and the first limiting rib being parallel to each other and disposed on the same side of the first side plate, an upper end of the first side plate being flush with an upper end of the first limiting rib, and a length of the first side plate being greater than a length of the first limiting rib;
the second side comprises a second side plate provided with a second limiting rib, the second side plate being perpendicular to the groove bottom plate, the second side plate being perpendicular to the second limiting rib, the groove bottom plate and the second limiting rib being parallel to each other and disposed on the same side of the second side plate, an upper end of the second side plate being flush with an upper end of the second limiting rib, and a length of the second side plate being greater than a length of the second limiting rib; and the first side plate, the first limiting rib, the groove bottom plate, the second side plate, and the second limiting rib form the guide groove.

8. The heavy metal detector according to claim 1, wherein the stirring device comprises a stirring barrel, a reaction cell and a drive motor, the drive motor being embedded in a housing of the main machine and disposed on the bottom of the stirring barrel, the drive motor being a rotating motor or an eccentric motor and configured to drive the stirring barrel to rotate or vibrate quickly, and the reaction cell being detachably disposed in the stirring barrel and configured to follow the rotation or vibration of the stirring barrel during detection.

9. The heavy metal detector according to claim 1, wherein the signal conversion module is connected to a voice prompt module and the display module, the voice prompt module being configured to receive an instruction of the main controller conveyed by the signal conversion module and perform voice broadcast, and the display module comprising a running indicator and an LCD touch screen.

10. The heavy metal detector according to claim 1, further comprising an external interface module, wherein the external interface module is disposed on a rear side of the base and comprises a RS232 serial interface, a USB interface, an Ethernet interface, a Mini USB interface and a power socket.
